(19) United States
(12) Patent Application Publication
(10) Pub. No.: US 2018/0044970 A1
(43) Pub. Date: Feb. 15, 2018

(54) DOOR FRAME

(71) Applicant: KINGSWAY ENTERPRISES (UK) LIMITED, Swanley (GB)

(72) Inventor: Benjamin HALL, Swanley (GB)

(21) Appl. No.: 15/674,832

(22) Filed: Aug. 11, 2017

(30) Foreign Application Priority Data
Aug. 15, 2016 (GB) 1613966.9

(51) Int. Cl. E06B 1/04; E05C 19/00; E06B 5/10; E05D 3/08; E06B 1/52; E06B 3/36

(52) U.S. Cl. CPC E06B 1/045; E06B 1/526; E06B 3/36; E06B 5/10; E05D 3/08; E05C 19/002

(57) ABSTRACT

A door frame assembly, comprising a first frame member comprising a first door frame casing for one side of a doorway and jambs projecting therefrom, a second frame member comprising a second door frame casing for another side of the doorway and jambs projecting therefrom, wherein the two frame members are arranged to fit together in a plurality of overlapping positions to form the door frame assembly such that the jambs of the first frame member overlap the jambs of the second frame member by different respective amounts in each of the plurality of overlapping positions to allow the door frame assembly to be applied to walls of different thicknesses.

### RELATED APPLICATION

The present application claims priority to GB Application No. 1613966.9, filed 15 Aug. 2016. The above-referenced application is hereby incorporated by reference into the present application in its entirety.

### FIELD

The present disclosure relates to door sets for use in healthcare applications. In particular, it relates to a door frame where an anti-barricade function is required, for example in a psychiatric ward.

### BACKGROUND

To ensure the safety of both patients and staff in healthcare environments, for example psychiatric wards, doorways need to provide a number of different functions. For example, a door set, which is comprised of a door leaf and a frame, should be able to resist lateral loads from patients trying to force their way in or out of the door. The doors should also allow two-way opening in the instance that opening in one direction is prevented by a patient barricading themselves in. The doors should have a single leaf in order to provide as simple a structure as possible. The door should also have anti-ligature functionality to reduce, or prevent entirely, the possibility of a patient causing themselves harm by using part of the door set. Each of these criteria should be met whilst also providing a door set that is capable of installation in a number of differently configured door spaces.

### SUMMARY

In accordance with an aspect of the disclosure there is provided a door frame assembly, comprising a first frame member comprising a first door frame casing for one side of a doorway and jambs projecting therefrom, a second frame member comprising a second door frame casing for another side of the doorway and jambs projecting therefrom, wherein the two frame members are arranged to fit together in a plurality of overlapping positions to form the door frame assembly such that the jambs of the first frame member overlap the jambs of the second frame member by different respective amounts in each of the plurality of overlapping positions to allow the door frame assembly to be applied to walls of different thicknesses.

Optionally, the jambs projecting from the first door frame casing comprise a first jamb element, a second jamb element and a first head jamb element between the first jamb element and the second jamb element, the jambs projecting from the second door frame casing comprise one or more third jamb elements, one or more fourth jamb elements and one or more second head jamb elements between the one or more third jamb elements and the one or more fourth jamb elements, and in each of the plurality of overlapping positions, at least a portion of the first jamb element overlaps at least a portion of the one or more third jamb elements, at least a portion of the second jamb element overlaps at least a portion of the one or more fourth jamb elements and/or at least a portion of the first head jamb element overlaps at least a portion of the one or more second head jamb elements.

Optionally, the first jamb element is substantially parallel to the second jamb element, and the one or more third jamb elements are substantially parallel to the one or more fourth jamb elements. Optionally, the first head jamb element is substantially perpendicular to the first jamb element and the second jamb element, and the one or more second head jamb elements are substantially perpendicular to the at least one third jamb element and the at least one fourth jamb element.

Optionally, the first head jamb element connects the first jamb element and the second jamb element at respective first ends of the first jamb element and the second jamb element, and at least one of the one or more second head jamb elements connects at least one of the one or more third jamb elements and at least one of the one or more fourth jamb elements at respective first ends of the one third jamb element and the one fourth jamb element.

Optionally, the first door frame casing is substantially perpendicular to the first jamb element, the second jamb element and the first head jamb element, and the second door frame casing is substantially perpendicular to the one or more third jamb elements, the one or more fourth jamb elements and the one or more second head jamb elements.

Optionally, the one or more third jamb elements comprise a first inner jamb element and a first outer jamb element substantially parallel to the first inner jamb element, the one or more fourth jamb elements comprise a second inner jamb element and a second outer jamb element substantially parallel to the second inner jamb element, the one or more second head jamb elements comprise an inner head jamb element between the first inner jamb element and the second inner jamb element, and an outer head jamb element substantially parallel to the inner head jamb element and between the first outer jamb element and the second outer jamb element, and in each of the plurality of overlapping positions, the first jamb element fits between the first inner jamb element and the first outer jamb element, the second jamb element fits between the second inner jamb element and the second outer jamb element and/or the first head jamb element fits between the inner head jamb element and the outer head jamb element.

Optionally, the inner head jamb element connects the first inner jamb element to the second inner jamb element at corresponding first ends of the first inner jamb element and the second inner jamb element. Optionally, a first space is provided between a first end of the first outer jamb element and a corresponding first end of the outer head jamb element, and a second space is provided between a first end of the second outer jamb element and a corresponding second end of the outer head jamb element.

Optionally, at least one of the first inner jamb element, the second inner jamb element and the inner head jamb element comprises a plurality of through holes for the insertion of fastening means. Optionally, at least one of the first inner jamb element, the second inner jamb element and the inner head jamb element is substantially planar and comprises a channel in which the through holes are formed. Optionally, when the first inner jamb element comprises a channel, the channel is configured to receive a locating ridge of a hinge, the locating ridge configured to resist lateral loading applied to the hinge when installed in the channel. Optionally, the through holes are formed substantially in a line parallel to an edge of the first inner jamb element, the second inner jamb element and/or the inner head jamb element opposite the second door frame casing. Optionally, the line is closer to the edge than to the second door frame casing. Optionally, the first outer jamb element, the second outer jamb element and/or the outer head jamb element each comprise a plurality of through slots configured to correspond to the plurality of through holes. Optionally, the first jamb element, the second jamb element and/or the first head jamb element each comprise a plurality of through slots configured to correspond to the plurality of through holes when the first frame member is assembled with the second frame member to form the door frame.

Optionally, the first inner jamb element, the second inner jamb element and the inner head jamb element each comprise a lip portion along an edge opposite the second door frame casing to form an architrave. Optionally, the first inner jamb element, the second inner jamb element and the inner head jamb element each comprise a first stepped portion at an edge proximal the second door frame casing. Optionally, the first outer jamb element, the second outer jamb element and the outer head jamb element each comprise a second stepped portion at an edge proximal the second door frame casing.

A dimension of each of the plurality of through slots parallel to an edge of the first inner jamb element, the second inner jamb element or the inner header element opposite the second door frame casing may be larger than the diameter of the through holes.

A dimension of each of the plurality of through slots perpendicular to an edge of the first inner jamb element, the second inner jamb element or the inner header element opposite the second door frame casing may be larger than the diameter of the through holes.

In accordance with an aspect of the disclosure there is provided a door set comprising a door leaf, a hinge member and the door frame assembly.

### BRIEF DESCRIPTION OF THE DRAWINGS

Exemplary embodiments of the disclosure shall now be described with reference to the drawings in which:

FIG. 1 shows an existing door set;

FIG. 2 shows a first member of a door frame assembly that is an embodiment of this disclosure;

FIG. 3 shows a second member of the door frame assembly;

FIG. 4 shows the door frame assembly;

FIG. 5 shows a plan view of the second member;

FIG. 5A shows a cross-sectional view through part of the door frame assembly;

FIG. 6 shows a perspective view of the second member;

FIG. 7 shows a header element of a member of the door frame assembly;

FIG. 8 shows a perspective view of the second member;

FIG. 9 shows a cross-sectional view through an assembled door set.

Throughout the description and the drawings, like reference numerals refer to like parts.

### DETAILED DESCRIPTION

The present disclosure relates to a door frame assembly assembled from two members, each of which provides one side of the assembled door frame. The two members are inserted into an opening in a wall from opposite sides of the wall. The two members slot together and are fastened to each other to hold them in place. The assembled door frame allows the installation of a two-way swing hinge that holds a door leaf that can open both ways with respect to the door opening.

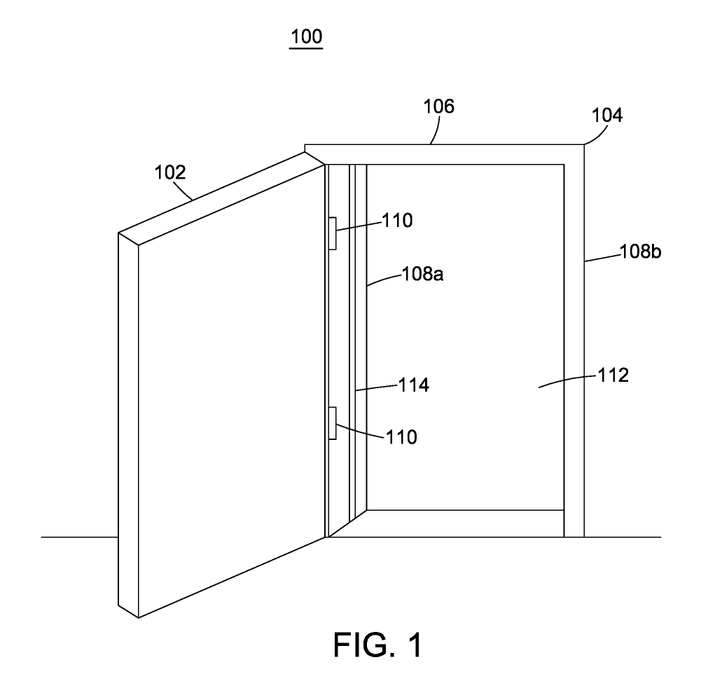

FIG. 1 shows a conventional door set 100. The door set 100 comprises a leaf 102 and a frame 104. The frame 104 is comprised of a header 106 a hinge jamb 108a and a lock jamb 108b. The jambs 108 are parallel to each other and are connected by the header 106, which is perpendicular to the jambs 108. The frame 104 defines a door opening 112 which is closed by the leaf 102 when the door is closed. The leaf 102 is mounted to the hinge jamb 108a by two hinges 110. The frame 104 also comprises a stop 114 that runs around the inner perimeter of the frame 104 and is configured to prevent the door leaf from rotating through the opening 112. A two-way door, that is able to open in both directions, would not have a stop 114.

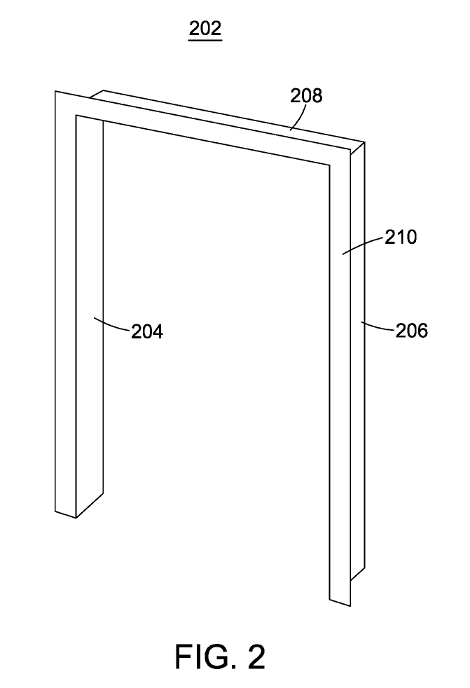

FIGS. 2 to 4 show a door frame assembly 200 that can be fitted to a door opening in a wall according to an example of the disclosure. FIG. 2 shows a first frame member 202 comprising a hinge jamb element 204, a lock jamb element 206, a header element 208 and a casing 210. The hinge jamb element 204 and the lock jamb element 206 are substantially perpendicular to the header element 208 in order to correspond to the jambs 108 and header 106 of a frame 104. The header element 208 is joined at one end to the hinge jamb element 204 and at the opposite end to the lock jamb element 206. The casing 210 is arranged along corresponding edges of the hinge jamb element 204, the lock jamb element 206 and the header element 208. Each of the hinge jamb element 204, the lock jamb element 206, the header element 208 and the casing 210 are substantially planar. The casing 210 is arranged perpendicularly to the hinge jamb element 204, the lock jamb element 206 and the header element 208. The first frame member 202 is arranged to be inserted into a door opening from one side of the door opening.

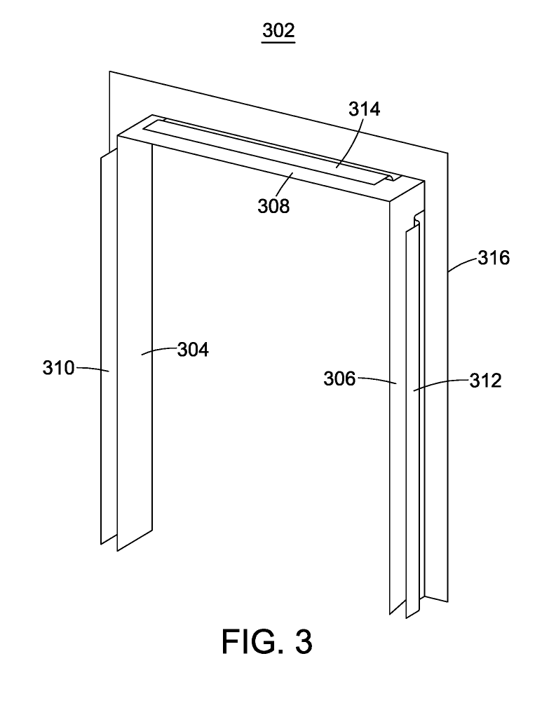

FIG. 3 shows a second frame member 302. During assembly of the frame assembly 200, the second frame member 302 is inserted into the door opening from the opposite side of the opening than the first frame member 202. The second frame member 302 comprises a first hinge jamb element 304, a first lock jamb element 306, a first header element 308 and a casing 316. The first hinge jamb element 304, the first lock jamb element 306, the first header element 308 and the casing 316 of the second frame member 302 correspond substantially in form and dimension to the hinge jamb element 204, the lock jamb element 206, the header element 208 and the casing 210 of the first frame member 202. However, the spacing between the first hinge jamb element 304 and the first lock jamb element 306 of the second frame member 302 is slightly smaller than the corresponding spacing on the first frame member 202. Similarly, the length of the first hinge jamb element 304 and the first lock jamb element 306 of the second frame member 302 is slightly less than the corresponding length on the first frame member 202. In this way, when the first frame member 202 and the second frame member 302 are placed together, the hinge jamb element 204, the lock jamb element 206 and the header element 208 of the first frame member 202 fit outside the first hinge jamb element 304, the first lock jamb element 306 and the first header element 308 of the second frame element 302 with respect to the door opening. The fit is a clearance fit such that a space is provided between corresponding elements of the first frame member 202 and the second frame member 302 as the first frame member 202 and the second frame member 302 are placed together. Alternatively, the fit may be a sliding fit, such that there is contact between corresponding elements of the first frame member 202 and the second frame member 302 as the first frame member 202 and the second frame member 302 are placed together.

The second frame member 302 also comprises a second hinge jamb element 310, a second lock jamb element 312 and a second header element 314. The second hinge jamb element 310 and the second lock jamb element 312 are attached to the first hinge jamb element 304 and first lock jamb element 306 respectively. The second hinge jamb element 310 and the second lock jamb element 312 each have a principal plane and an offset section for connection to the first hinge jamb element 304 and first lock jamb element 306. The principal planes of the second hinge jamb element 310 and the second lock jamb element 312 are arranged parallel to and outside the first hinge jamb element 304 and first lock jamb element 306 respectively with respect to the door opening. The second header element 314 is attached to the first header element 308. The second header element 314 also has a principal plane and an offset section for connection to the first header element 308. The principal plane of the second header element is arranged parallel to and above the first header element 308 with respect to the door opening.

The spacing between the principal planes of the second hinge jamb element 310 and the second lock jamb element 312 of the second frame member 302 is slightly larger than the corresponding spacing on the first frame member 202. Similarly, the height of the principal plane of the second header element 314 of the second frame member 302 from the ground is slightly larger than the height of the header element 208 of the first frame member 202. In this way, gaps are provided between the jamb elements and header elements of the second frame member 302 into which the jamb elements and header element of the first frame member 202 fit when the first frame member 202 and the second frame member 302 are assembled together. The fit is a clearance fit such that a space is provided between corresponding elements of the first frame member 202 and the second frame member 302 as the first frame member 202 and the second frame member 302 are placed together. Alternatively, the fit may be a sliding fit, such that there is contact between corresponding elements of the first frame member 202 and the second frame member 302 as the first frame member 202 and the second frame member 302 are placed together. The correspondence between the jamb elements and header element of the first frame member 202 and the gaps provided by the second frame member 302 help to locate the two frame members together and maintain them in relative position. The second hinge jamb element 310, the second lock jamb element 312 and the second header 314 of the second frame element 302 are not directly connected to each other.

The composite parts of the first frame member 202 (the jamb elements 204, 206, header element 208 and casing 210) are formed separately and welded together. Similarly, the composite parts of the second frame member 302 (the jamb elements 304, 306, 310, 312, header elements 308, 314 and casing 316) are formed separately and welded together. Alternatively, the parts may be joined by adhesive or any suitable attachment means. Alternatively, the first frame member 202 and the second frame member 302 may each be integrally formed. In this embodiment, the first frame member 202 and the second frame member 302 are made of steel. Other materials which can be formed into the desired shapes which are also strong and rigid are also envisaged.

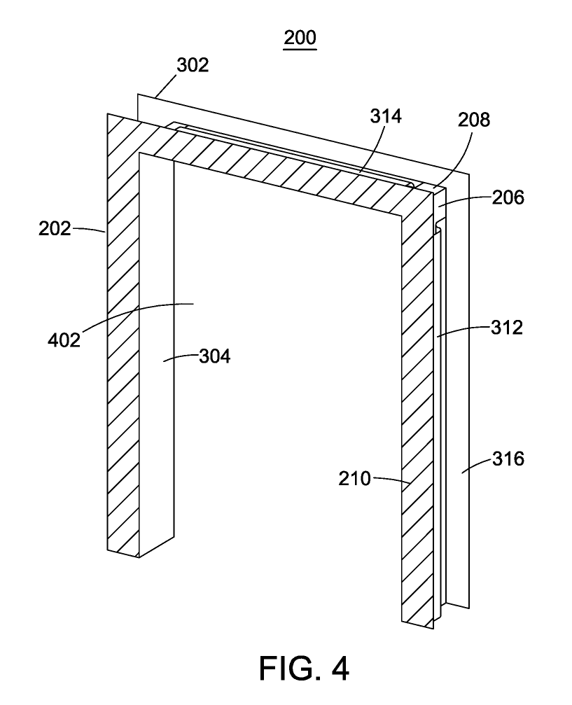

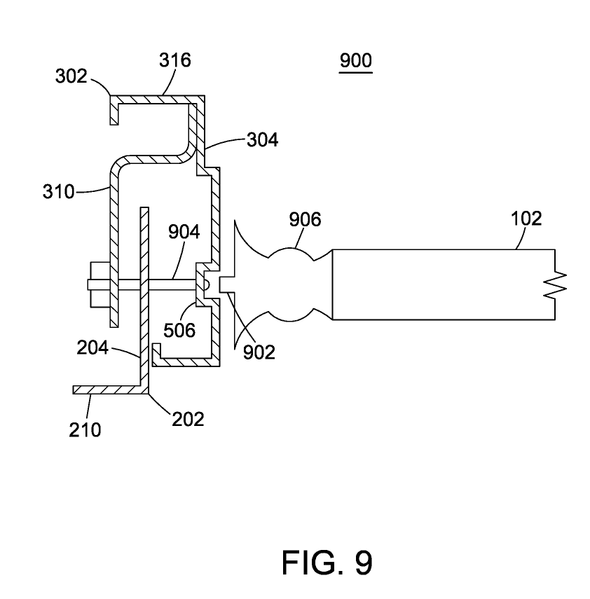

FIG. 4 shows the assembly of the first frame member 202 and the second frame member 302 to make the frame assembly 200. The jamb elements 204 and 206 and header 208 of the first frame member 202 fit inside the gaps provided by the jamb elements 304, 306, 310 and 312 and the header elements 308 and 314 of the second frame member 302, as previously described. A door opening 402 is defined by the inner surfaces of the first hinge jamb element 304, first lock jamb element 306 and first header element 308 of the second frame member 302. The casings 210 and 316 are visible from either side of the wall in which the door opening 402 is formed. Such a door frame assembly 200 allows a two-way hinge and leaf to be attached, as will be explained in relation to FIG. 9.

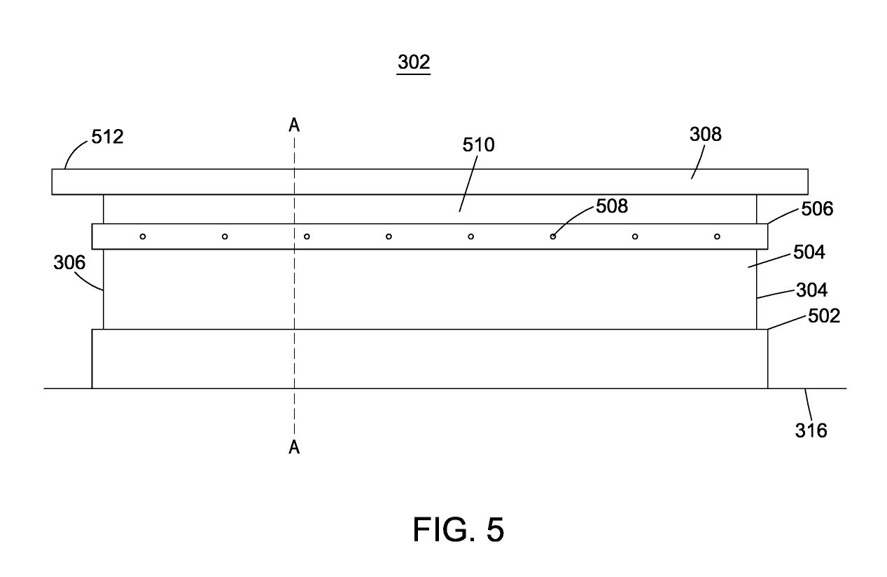

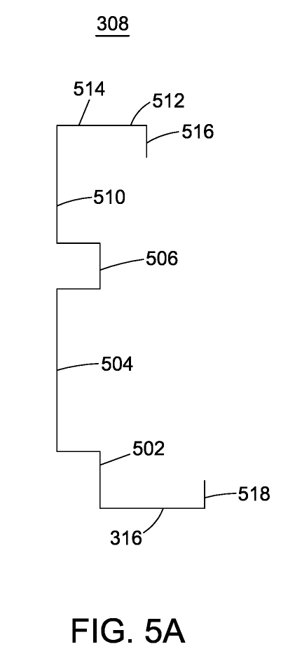

FIG. 5 shows a top view of the second frame member 302. In this figure, the second hinge jamb element 310, second lock jamb element 312 and second header element 314 shown in FIG. 3 have been cut away. As such, the first header element 308 can be seen in plan view. The cross-sectional profile of the first hinge jamb element 304 and the first lock jamb element 306 can also be seen and is also shown in FIG. 5A. With continued reference to FIG. 5, the first hinge jamb element 304, the first lock jamb element 306 and the first header element 308 have the same cross-sectional profile.

The first header element 308 has a principal plane defined by a first web portion 504 and a second web portion 510. The first header element 308 also has a stepped portion 502 and channel 506, which extend from the principal plane of the first header element 308 away from the door opening. This is shown by the offset of the stepped portion 502 and the channel 506 from the first web portion 504 and the second web portion 510. The stepped portion 502 is formed at an edge of the first header element 308 that connects to the casing 316. This is to allow the fixing of an anti-barricade doorstop to the door frame assembly 200. The channel 506 is square or rectangular in cross-section. Other cross-sections which allow insertion of fastening elements without interference with the principal plane are also envisaged. The first header element 308 also has a lip portion 512 attached to the second web portion 510, which is discussed in more detail in relation to FIG. 5A.

The channel 506 has a plurality of through holes 508 formed in the channel face parallel to the principal plane of the first header element 308. The through holes allow the insertion of fastening means, for example, screws and/or bolts. These are used to fasten the first frame member 202 to the second frame member 302 when the frame assembly 200 is assembled.

FIG. 5A shows a cross-section of the first header element 308 through the section A-A shown in FIG. 5. The lip portion 512 has a first part 514 that is perpendicular to the second web portion 510 and a second part 516 that is parallel to the second web portion 510 and spaced from it by the first part 514. The casing 316 also has a casing part 518 that is perpendicular to the casing 316. The lip portion 512 and the casing part 518 serve to form an architrave on either side of the door frame assembly 200. As discussed, this cross-sectional profile is the profile of the first hinge jamb element 304 and the first lock jamb element 306 as well as the first header element 308

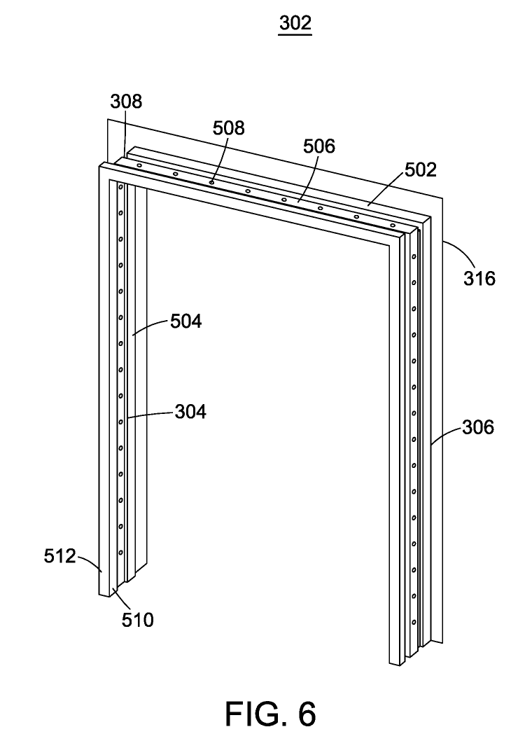

FIG. 6 shows a perspective view of the second frame member 302 with the second hinge jamb element 310, second lock jamb element 312 and second header element 314 cut away. The offset of the channel 506 from the first web portion 504 and the second web portion 510 allows the insertion of fastening elements into through holes 508 without interference with the principal plane of the frame element 302. As the cross-sectional profile is consistent along the first hinge jamb element 304, first header element 308 and first lock jamb element 306, fastening is allowed along all three sides of the door frame assembly 200. Therefore, a hinge and leaf can be attached to the first hinge jamb element 304, flush with the first web portion 504 and second web portion 510, and without interference from fastening elements used to hold the first frame member 202 and the second frame member 302 together. This will be shown in more detail in relation to FIG. 9.

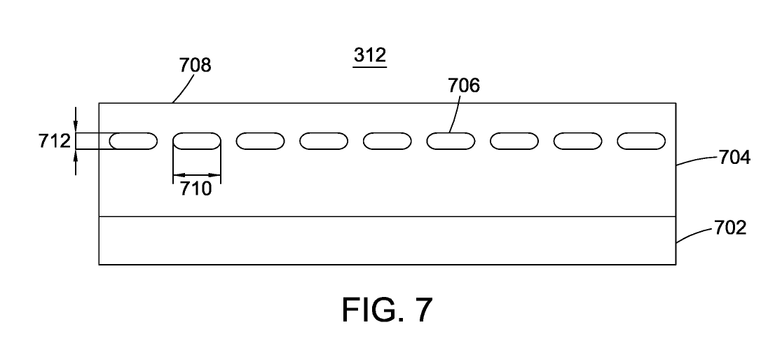

FIG. 7 shows a detailed illustration of the second header element 312 of the second frame member 302. The second header element 312 has a web 704 that defines the principal plane of the second header element 312. The second header element 312 also has an offset portion 702 at the edge closest to the casing 316. The offset portion 702 serves to space the second header element 312 from the second frame member 302 to allow the correct gap for first frame member 202 to locate into. The web 704 has a plurality of through slots 706 arranged along a line parallel to the edge 708 of the second header element opposite the offset portion 702. The slots 706 are arranged to correspond to the through holes 508 in the first header element 308. The slots 706 are arranged closer to the edge 708 than to the offset portion 702 to line up with the holes 508 when the second frame member 302 is assembled. The slots 706 are arranged to have a width 710 that is larger than the diameter of the through holes 508. This provides a clearance for fastening elements to be inserted when the second frame member 302 is installed. The slots 706 are also arranged to have a depth 712 that is larger than the diameter of the through holes 508 in the first header element 308. This also provides a clearance for fastening elements to be inserted when the second frame member 302 is installed. This configuration applies equally to the second hinge jamb element 310 and the second lock jamb element 312.

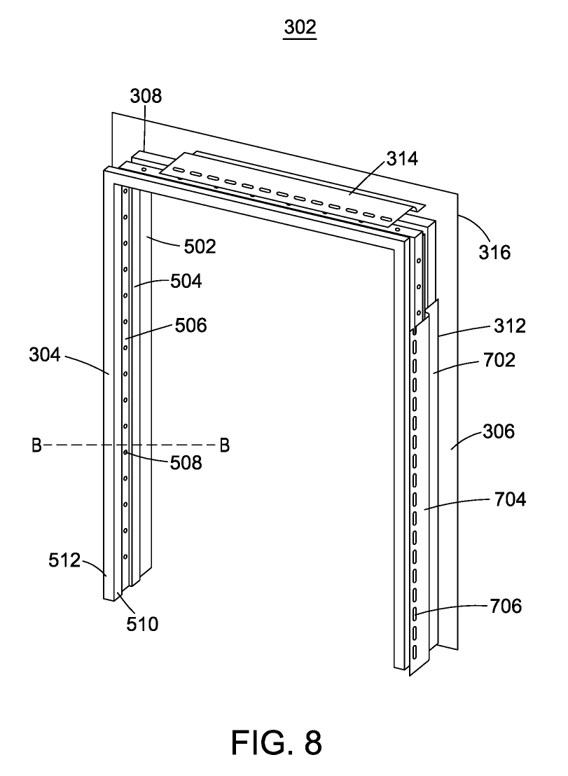

FIG. 8 shows a perspective view of the second frame member as shown in FIG. 6 with the second hinge jamb element 310 (not visible), second header element 314 and second lock jamb element 312 present. It can be seen that the slots 706 correspond to the holes 508 provided in the channel 506 of the first hinge jamb element 304, first header element 308 and first lock jamb member 306.

The jamb elements 204, 206 and header element 208 of the first frame member 202 do not have any through holes, and fastening elements 904 penetrate the elements of the first frame member 202 during assembly. This provides flexibility to the thickness of the wall in which the frame is to be assembled, as there is no requirement for specific alignment of the through holes 508 and through slots 706 of the second frame member with any corresponding holes or slots in the first frame member 202.

The assembly can be seen in FIG. 9, which is a view of a door set 900 through the cross-section B-B shown in FIG. 8 once the first frame member 202 and the second frame member 302 have been assembled together. The first frame member 202 and the second frame member 302 are fastened together using a fastening element in the form of a nut and bolt 904 inserted through the corresponding through holes 508 and through slots 706 of the second frame member 302 and penetrating the first jamb element 204 of the first frame member 202.

As discussed above, the cross-sectional profile of the first hinge jamb element 304, first header element 308 and first lock jamb element 306 of the second frame member 302 allows a leaf 102 and hinge 906 to be attached to the frame assembly 200 without interference from the fastening elements used to hold the first frame member 202 and the second frame member 302 together. This profile also allows the insertion of a hinge 906 with a ridge element 902 that acts against lateral loading of the door set 900 when it is fully assembled. The ridge element 902 is received in the channel 506 of the first hinge jamb element 304. When a lateral load is applied to the door leaf 102, the ridge element 902 engages with the lateral surfaces of the channel 506 and acts against the lateral load. This helps to prevent a patient forcing their way through the door by removing the door leaf 102 from the frame assembly 200 by lateral force. The hinge 906 may be a hinge as described in UK Patent No. 2516093.

During assembly, the first frame member 202 is inserted into a door opening in a wall from one sides of the wall. The second frame member 302 is inserted into the door opening from the opposite side of the wall to the first frame member 202. The jamb elements 202 and 204 of the first frame member 202 slot into the gaps between the jamb elements 304, 306, 310 and 312 of the second frame member 302. The header element 208 of the first frame member 202 slots into the gap between the header elements 308 and 314 of the second frame member 302. This allows the two frame members 202 and 302 to be located together. The degree to which the elements of the first frame member 202 overlap those of the second frame member 302 when slot into the gaps in the second frame member 302 is adjustable based on the thickness of the wall. Once in position, fastening elements in the form of nuts and bolts 904 are inserted through the through holes 508 and through slots 706 of the second frame member 302 and through the jamb elements of the first frame member 202 to hold the two frame members together. The two-way swing hinge 906 that holds the door leaf 102 is installed on the assembled door frame assembly 200 to provide the completed door set 900. The two-way swing hinge 906 allows the door to open both ways with respect to the door opening.

In an alternative configuration, the first frame member 202 also may have through slots in its jamb elements 204 and 206 and its header element 208 which correspond to the through holes 508 and through slots 706 in the corresponding elements of the second frame member 302. In this way, when the first frame member 202 and second frame member 302 are assembled such that the jamb and header elements 204, 206 and 208 of the first frame member 202 slot into the gaps between the jamb elements 304, 306, 310 and 312 and the header elements 308 and 314 of the second frame member 302, as previously described, the through holes 508 and through slots 706 of the second frame member 302 are aligned with the through holes in the first frame member 202 such that the two frame members can be fastened together.

The door frame assembly 200 and door set 900 disclosed above provide a simple assembly for framing a door opening. The relative positioning of the jamb and header elements of the two frame members 202 and 302 helps to locate the two frame members 202 and 302 together and maintain them in relative position. The two frame members 202 and 302 can be slotted together at varying degrees of overlap in order to take account of the thickness of the wall in which the frame assembly 200 is being installed. The profile of the jamb elements means that the fastening elements can be inserted whilst leaving space for a hinge to be attached to the frame without interference from the fastening elements. This profile also allows the insertion of a hinge with a ridge element that acts against lateral loading of the door set 900 when it is fully assembled. This can prevent patients in a psychiatric ward in which the door set 900 is implemented from trying to force their way in or out of the doorway. Such a hinge may be a two-way swing hinge that holds a door leaf that can open both ways with respect to the door opening. Such a hinge can have a single leaf that opens both ways in order to provide as simple a structure as possible. The two-way opening action of the door also prevents by a patient barricading themselves on one side of the door. Such a hinge may also have anti-ligature functionality to reduce, or prevent entirely, the possibility of a patient causing themselves harm by using part of the door set 900.

Various modifications may be made to the described embodiments without departing from the scope of the invention as defined by the accompanying claims.

1. A door frame assembly, comprising:
a first frame member comprising a first door frame casing for one side of a doorway and jambs projecting therefrom;
a second frame member comprising a second door frame casing for another side of the doorway and jambs projecting therefrom;
wherein the two frame members are arranged to fit together in a plurality of overlapping positions to form the door frame assembly such that the jambs of the first frame member overlap the jambs of the second frame member by different respective amounts in each of the plurality of overlapping positions to allow the door frame assembly to be applied to walls of different thicknesses.

2. The door frame assembly of claim 1, wherein:
the jambs projecting from the first door frame casing comprise a first jamb element, a second jamb element and a first head jamb element between the first jamb element and the second jamb element;
the jambs projecting from the second door frame casing comprise one or more third jamb elements, one or more fourth jamb elements and one or more second head jamb elements between the one or more third jamb elements and the one or more fourth jamb elements; and
in each of the plurality of overlapping positions, at least a portion of the first jamb element overlaps at least a portion of the one or more third jamb elements, at least a portion of the second jamb element overlaps at least a portion of the one or more fourth jamb elements and/or at least a portion of the first head jamb element overlaps at least a portion of the one or more second head jamb elements.

3. The door frame assembly of claim 2, wherein,
the first jamb element is substantially parallel to the second jamb element; and
the one or more third jamb elements are substantially parallel to the one or more fourth jamb elements.

4. The door frame assembly of claim 2, wherein,
the first head jamb element is substantially perpendicular to the first jamb element and the second jamb element; and
the one or more second head jamb elements are substantially perpendicular to the at least one third jamb element and the at least one fourth jamb element.

5. The door frame assembly of claim 2, wherein:
the first head jamb element connects the first jamb element and the second jamb element at respective first ends of the first jamb element and the second jamb element; and
at least one of the one or more second head jamb elements connects at least one of the one or more third jamb elements and at least one of the one or more fourth jamb elements at respective first ends of the one third jamb element and the one fourth jamb element.

6. The door frame assembly of claim 5, wherein:
the first door frame casing is substantially perpendicular to the first jamb element, the second jamb element and the first head jamb element; and
the second door frame casing is substantially perpendicular to the one or more third jamb elements, the one or more fourth jamb elements and the one or more second head jamb elements.

7. The door frame assembly of claim 2, wherein:
the one or more third jamb elements comprise a first inner jamb element and a first outer jamb element substantially parallel to the first inner jamb element;
the one or more fourth jamb elements comprise a second inner jamb element and a second outer jamb element substantially parallel to the second inner jamb element;
the one or more second head jamb elements comprise an inner head jamb element between the first inner jamb element and the second inner jamb element, and an outer head jamb element substantially parallel to the inner head jamb element and between the first outer jamb element and the second outer jamb element; and
in each of the plurality of overlapping positions, the first jamb element fits between the first inner jamb element and the first outer jamb element, the second jamb element fits between the second inner jamb element and the second outer jamb element and/or the first head jamb element fits between the inner head jamb element and the outer head jamb element.

8. The door frame assembly of claim 7, wherein the inner head jamb element connects the first inner jamb element to the second inner jamb element at corresponding first ends of the first inner jamb element and the second inner jamb element.

9. The door frame assembly of claim 7, wherein:
a first space is provided between a first end of the first outer jamb element and a corresponding first end of the outer head jamb element; and
a second space is provided between a first end of the second outer jamb element and a corresponding second end of the outer head jamb element.

10. The door frame assembly of claim 7, wherein at least one of the first inner jamb element, the second inner jamb element and the inner head jamb element comprises a plurality of through holes for the insertion of fastening means.

11. The door frame assembly of claim 10, wherein at least one of the first inner jamb element, the second inner jamb element and the inner head jamb element is substantially planar and comprises a channel in which the through holes are formed.

12. The door frame assembly of claim 11, wherein, when the first inner jamb element comprises a channel, the channel is configured to receive a locating ridge of a hinge, the locating ridge configured to resist lateral loading applied to the hinge when installed in the channel.

13. The door frame assembly of claim 10, wherein the through holes are formed substantially in a line parallel to an edge of the first inner jamb element, the second inner jamb element and/or the inner head jamb element opposite the second door frame casing.

14. The door frame assembly of claim 13, wherein the line is closer to the edge than to the second door frame casing.

15. The door frame assembly of claim 10, wherein the first outer jamb element, the second outer jamb element and/or the outer head jamb element each comprise a plurality of through slots configured to correspond to the plurality of through holes.

16. The door frame assembly of claim 10, wherein the first jamb element, the second jamb element and/or the first head jamb element each comprise a plurality of through slots configured to correspond to the plurality of through holes when the first frame member is assembled with the second frame member to form the door frame.

17. The door frame assembly of claim 7, wherein the first inner jamb element, the second inner jamb element and the inner head jamb element each comprise a lip portion along an edge opposite the second door frame casing to form an architrave.

18. The door frame assembly of claim 7, wherein the first inner jamb element, the second inner jamb element and the inner head jamb element each comprise a first stepped portion at an edge proximal the second door frame casing.

19. The door frame assembly of claim 7, wherein the first outer jamb element, the second outer jamb element and the outer head jamb element each comprise a second stepped portion at an edge proximal the second door frame casing.

20. A door set comprising a door leaf, a hinge member and the door frame assembly of claim 1.
